(19) United States
(12) Patent Application Publication
(10) Pub. No.: US 2009/0095118 A1
(43) Pub. Date: Apr. 16, 2009

(54) Inner cable for push-pull control cable and method for fabricating the same

(76) Inventor: Young-Choong Kim, Seoul (KR)

Correspondence Address: GWIPS;Peter T. Kwon, Gwacheon P.O. Box 72, 119 Byeolyang Ro, Gwacheon City, Gyeonggi-Do, 427-600, KR

(21) Appl. No.: 12/285,583

(22) Filed: Oct. 9, 2008

(30) Foreign Application Priority Data
Oct. 11, 2007 (KR) 10-2007-0102591

(51) Int. Cl. F16C 1/20; B23P 11/00

(52) U.S. Cl. 74/502.5; 29/428

(57) ABSTRACT

Disclosed is an inner cable for a push-pull control cable and a method for manufacturing the inner cable. The inner cable of a push-pull control cable applied to various control system including a steering system and a method for manufacturing the inner cable can generally increase durability of a control cable and reliability of a steering system, and can be easily manufactured. The inner cable includes a core wire with a predetermined length, which is formed by twisting a plurality of wire strands; a coiled wire, which is assembled with one end of the core wire in such a manner that the coiled wire winds the outer circumferential surface of the core wire in a spiral shape; and synthetic resin coating formed at a remaining part of the core wire, except for a part assembled with the coiled wire.

### BACKGROUND OF THE INVENTION

1. Field of the invention

The present invention relates to an inner cable for a control cable, and more particularly to an inner cable for a push-pull control cable which can increase durability of a push-pull control cable applied to various kinds of control system including a steering system of a marine vehicle, such as a boat, etc. and reliability of a control system employing the push-pull control cable, and also allows the push-pull control cable to be easily manufactured.

2. Description of the Prior Art

In general, a push-pull control cable provides a means for transferring linear motion from one position to another position.

Such a push-pull control cable includes a steering system of a motor boat, etc. so as to be used for heavy equipment, such as jet skis, vehicles, fork lifts, etc., which require steering operation.

Among these, a steering system of the motor boat M includes a system which converts operational force of a steering wheel to a linear movement of a rack through a rack-pinion apparatus and remotely controls a direction of an engine through a push-pull control cable connected with the rack, and a system which transfers operational face of a steering wheel to a cable through a rotary helm so that the system remotely controls a direction of an engine.

FIG. 1 is a view illustrating a motor boat, to which a steering system for a motor boat is applied, FIG. 2a is a perspective view of a main body of a steering system for a motor boat, and FIG. 2b is a reference photo showing a conventional inner cable for a push-pull control cable, which is applied to a steering system for a motor boat.

Referring to these drawings, the rotary steering system includes a steering wheel 10 for desirably changing a progressing direction of the motor boat, a rotary helm 20 for receiving operational force of the steering wheel and rotating, and a push-pull control cable for transfer motive power, which is engaged with a gear formed at an outer circumferential surface of a gear box 30 of the rotary helm 20 so as to transfer push-pull force.

At this time, the structure of a conventional inner cable 40a for a push-pull control cable includes a stranded core wire (hereinafter, referred to as “a core wire”), which is formed by pieces of twisted wires, and a spiral wire 42a, which is wound on an outer circumferential surface of the entire length of the core wire 41 while making a spiral strand-shape so as to be engaged with a gear groove 30a formed at an outer circumferential surface of the gear box 30 of the rotary helm 20.

Also, the spiral wire 42a is shaped like a spiral strand and is wound on the outer circumferential surface of the core wire 41 while maintaining a pitch p (see FIG. 2b) having a predetermined interval between turns (a turn meanings winding at one time) so as to maintain flexibility of the core wire 41.

That is, the spiral wire 42a wound on the outer circumferential surface of the core wire 41 of the inner cable 40a for a push-pull control cable has a structure similar to a worm structure and a worm wheel structure among gear structures. The spiral wire 42a functions as a worm, and the gear box 30 the rotary helm 20 functions as a worm wheel.

However, the conventional inner cable 40a for a push-pull control cable applied to the above described rotary steering system has a problem, which is described below.

Firstly, the conventional inner cable 40a for a push-pull control cable has spiral wire 42a wound on an outer circumferential surface of the entire length of the core wire 41 while having a strand-shape, regardless of the length of the core wire.

That is, if the entire length of a push-pull control cable included in a steering system of the motor boat M (i.e. whole length of the core wire 41) is 5M, the spiral wire 42a to function as a worm is wound on an outer circumferential surface of the core wire along the entire length of 5M.

Because of this, there is a disadvantage in that manufacturing unit cost increases, unnecessary loss is caused in transferring steering force, and reliability of and durability of a steering system is reduced.

Concretely, the inner cable 40a for a push-pull control cable, which is installed between the gear box 30, to which operational force of the steering wheel is transferred, and an engine E generating power, is installed in such a manner that it can move along a pipe 80 in a state where the inner cable is bent due to interference with other structure, etc. according to each section. If compression force and tensile force are repeatedly applied to the inner cable 40a for push-pull control cable during a process where the operation of a steering wheel is repeatedly performed so as to adjust the direction of the engine, at the time when the compression force is applied, much bigger compression force is applied to a part, which is connected with the gear box 30, of the inner cable 40a for push-pull control cable due to a bent section positioned at a rear side of the inner cable, in comparison with other parts of the inner cable.

That is, due to supporting force of the inner cable 40a for push-pull control cable, which is generated at a curved section of the inner cable, a portion of the inner cable 40a, to which compression force is directly transferred because the portion is directly connected with the gear box 30, is easily bent. Therefore, there is a need for moving the inner cable 40a without bending by smaller compression force at a portion of the inner cable, which is directly connected with the gear box 30, in such a manner that the inner cable 40a is allowed to be flexibly operated at the curved section.

However, the conventional inner cable 40a for a push-pull control cable has a spiral wire 42a wound on whole sections thereof so that big supporting force is unnecessarily generated at the curved section.

Accordingly, bigger compression force is applied to the inner cable 40a for a push-pull control cable so as to operate the steering wheel. Because of this, concentrative bending is generated in a section of the inner cable 40a, which is connected with the gear box 30. As a result, abrasion generated due to interference with other components is promoted so that durability and reliability are reduced.

As described above, the conventional inner cable 40a for the push-pull control cable has an economical problem and a problem in reliability as well as durability of the steering system. However, it is very difficult to resolve such problems by using the structure of the conventional inner cable 40a for the push-pull control cable, which is illustrated in FIG. 2b, and a method for manufacturing the inner cable. The reason will be described below.

That is, the conventional inner cable 40a for the push-pull control cable, which is illustrated in FIG. 2b, is formed by winding a spiral wire 42a on an outer circumferential surface of a core wire 41. At this time, in order to maintain a predetermined pitch as well as coupling force with the core wire 41, the spiral wire 42a has to be wound while tension is applied to the core wire 41 and the spiral wire 42a so as to strain them.

Then, the inner cable 40a for a push-pull control cable, which has been formed by winding the spiral wire 42a on the outer circumferential surface of the core wire 41, undergoes a thermal process. After the thermal process, the inner cable undergoes a cooling process and a drying process to be electropainted. The electropainted inner cable 40a is cut into a required length, e.g. 5M, 6M, etc. so as to be used when the inner cable is applied to a steering system.

Therefore, the conventional inner cable 40a for a push-pull control cable, which is manufactured by such a manufacturing method, is a state where the entire length of the inner cable 40a is wound by the spiral wire 42a when the inner cable is applied to the motor boat M. Therefore, big frictional resistance is generated in steering operation. Particularly, in a case of an inner cable 40a for a push-pull control cable which is 6M, a spiral wire 42a is wound on whole sections of the inner cable which is 6M, so that the entire inner cable 40a is stiff. As a result, the inner cable can not be easily bent, even in a curved section where the inner cable has to be bent so that interference and frictional resistance are continuously generated between the inner cable 40a and the pipe 80. Therefore, in an actual situation, the life of the push-pull control cable is reduced due to the cable, itself.

As described above, in a steering system of the motor boat M, a part of the cable, on which the spiral wire 42a has to be actually wound, is only a part of whole length of the inner cable 40a (a part, which is about 60 cm, connected with the rotary helm in a case of the whole length being 5M or 6M), i.e. a travel road which is engaged with the gear box 30 of the rotary helm 20 or is released therefrom. It is preferable that the spiral wire 42a is wound only on this part. However, in the conventional inner cable 40a for a push-pull control cable, because it is impossible to wind the spiral wire 42a on only a desired part of the inner cable due to technical limitation in the above described manufacturing method, there is no choice but to wind the spiral wire 42a on the whole length of the inner cable.

Meanwhile, it can be supposed that the spiral wire 42a can be wound on only a required part (a part which is about 60 cm connected with the rotary helm) in manufacturing the conventional inner cable 40a for a push-pull control cable, but this is very difficult due to technical problems, and is also uneconomical. That is, in order to wind the spiral wire 42a on the core wire 41, tension has to be actually applied to the spiral wire 42a. However, it is extremely difficult in processes to apply tension to the spiral wire 42a and perform a thermal process to it so as to wind the spiral wire 42a on only a part of an outer circumferential surface of the core wire 41 in a state of the core wire 41 being cut into a short length. Also, this is very non-efficient in an economical view.

Therefore, in order to reduce abrasion of the push-pull control cable, it is very advantageous to keep a straight state of a linear section, which is connected with the gear box 30, of the inner cable 40a for the push-pull control cable, even in a case where compression force is applied to the section. Also, in order to extend the life of the push-pull control cable and transfer force, it is very advantageous to form a remaining sections, which becomes a curved section, except for the liner section, which is connected with the gear box 30, of the inner cable 40a for a push-pull control cable, to be more flexible in comparison with the conventional inner cable.

### SUMMARY OF THE INVENTION

Accordingly, the present invention has been made to solve the above-mentioned problems occurring in the prior art, and the present invention provides an inner cable for a push-pull control cable constituting various kinds of control systems including a steering system and a method for manufacturing the same so as to generally increase durability of the push-pull control cable and reliability of a steering system, etc., and to allow the inner cable to be easily manufactured.

In accordance with an aspect of the present invention, there is provided an inner cable for a push-pull control cable, the inner cable including: a first core wire formed by twisting a plurality of wire strands; a coiled wire, which has a spiral shape and is assembled with the first core wire in such a manner that the coiled wire surrounds an outer circumferential surface of the first core wire; a second core wire formed by twisting a plurality of wire strands similarly to the first core wire, the second core wire having an outer surface coated with synthetic resin coating; and a connector for connecting an assembly, which is formed by assembling the coiled wire with an outer surface of the first core wire, and the second core wire with each other.

In accordance with another aspect of the present invention, there is provided a method for manufacturing an inner cable for a push-pull control cable, the method including the step of: forming an assembly in such a manner that a coiled wire of a spiral coil-shape is assembled with a first core wire through one end of the first core wire; forming a second core wire by coating synthetic resin having a predetermined thickness on an outer surface of the second core wire, the second core wire being a wire formed by twisting a plurality of wire strands similarly to the first core wire; and connecting the assembly, which is formed by assembling the coiled wire with the outer surface of the first core wire, with the second core wire with each other through a connector.

In accordance with another aspect of the present invention, there is provided an inner cable for a push-pull control cable, the inner cable including: a core wire having a predetermined length, the core wire being formed by twisting a plural of wire strands; synthetic resin coating formed on a predetermined part of the core wire; and a coiled wire of a spiral shape, the coiled wire surrounding an outer circumferential surface of a remaining part of the core wire, except for the part coated with synthetic resin.

In accordance with another aspect of the present invention, there is provided a method for manufacturing an inner cable for a push-pull control cable, the method including the steps of: forming a core wire by twisting a plurality of wire strands; coating an outer surface of the core wire with synthetic resin with a predetermined thickness; removing a predetermined part of the synthetic resin, with which one side end of the core wire is coated; assembling a coiled wire of a spiral shape with the part of the core wire, from which synthetic resin coating has been removed; arranging a pitch of the coiled wire; and settling the coiled wire on the core coil.

In accordance with another aspect of the present invention, there is provided an inner cable for a push-pull control cable, the inner cable including: a core wire having a predetermined length, the core wire being formed by twisting a plurality of wire strands; synthetic resin coating formed on a predetermined part of the core wire; and an armor assembled with a remaining part of the core wire, except for the part coated with synthetic resin, in such a manner that the armor surrounds an outer circumferential surface of the core wire.

In accordance with another aspect of the present invention, there is provided a method for manufacturing an inner cable for a push-pull control cable, the method including the steps of: forming a core wire by twisting a plurality of wire strands; coating an outer surface of the core wire with synthetic resin with a predetermined thickness; removing a predetermined part of the synthetic resin, which one side end of the core wire is coated; assembling an armor of a spirally winding shape, with the part of the core wire, from which synthetic resin coating has been removed; and settling the armor on the core wire.

According to the present invention, an inner cable for a push-pull control cable, which can show its elastic force without a thermal process and can be used for a long time due to superior durability, can be provided.

Also, a process for applying tension to a coiled wire and a thermal process, which are performed in manufacturing an inner cable for a push-pull control cable, are deleted. As a result, there is an advantage in that operations of manufacturing an inner cable are easily performed, productivity is improved, and manufacturing cost is reduced.

For example, in a case of the inner cable for a push-pull control cable according to the present invention being applied to a motor boat, a coiled wire exists on an outer surface of only a part of the core wire, the part being a section from a point of the inner cable, which is caught at a time when the inner cable is pulled with the maximum degree from an connection part with the gear-box 30 of the rotary helm 20, to a point just before a first curved section. Meanwhile, the coiled wire does not exist at a remaining part of the inner cable. Therefore, the part of the inner cable, in which the coiled wire does not exist, is flexibly operated in a curved section, and compression force transferred to a part maintaining a linear length is simultaneously reduced. As a result, frictional force of the push-pull control cable is effectively prevented so that durability and reliability of the steering system can increase.

As described above, according to the present invention, an inner cable for a push-pull control cable is improved so as to increase durability of the push-pull control cable. Also, reliability of a steering system, etc, using a push-pull control cable is generally increased, and the push-pull control cable can be easily manufactured.

### BRIEF DESCRIPTION OF THE DRAWINGS

The above and other objects, features and advantages of the present invention will be more apparent from the following detailed description taken in conjunction with the accompanying drawings, in which:

FIG. 1 is a view illustrating a motor boat, to which a steering system for a motor boat is applied;

FIG. 2a is a perspective view of a main part of a steering system for a motor boat;

FIG. 2b is a reference picture showing a conventional control cable applied to a steering system for a motor boat;

FIG. 3a is a perspective view of an inner cable for a push-pull control cable according to the present invention;

FIG. 3b is an exploded perspective view of an inner cable for a push-pull control cable according to the present invention;

FIG. 3c is a front view showing the assembled state of the inner cable for a push-pull control cable, which is shown in FIG. 3b, in which a connector part as a main part is shown in a sectional view;

FIG. 3d is a front view showing the assembled state of the inner cable for a push-pull control cable, which is shown in FIG. 3b, in which a connector part as a main part according to another embodiment is shown in a sectional view;

FIGS. 4a to 4m are views showing processes of manufacturing an inner cable of a push-pull control cable according to the present invention;

FIG. 4a is a front view of a first core wire;

FIG. 4b is a front view of a second core wire coated with nylon, in which a part of the second core wire is shown in a sectional view;

FIG. 4c is a front view of a second core wire, in which a part of nylon, with which on one end of the second core wire is coated, is removed;

FIG. 4d is a front view of the first core wire in a state before a coiled wire is assembled with the first core wire through one end of the first core wire;

FIG. 4e is a front view of the first core wire in a state where the the coiled wire is completely wound on an outer circumferential surface of the first core wire;

FIG. 4f is a sectional view of the first core wire inserted in a mold so as to arrange pitches of the coiled wire assembled with the first core wire;

FIG. 4g is a sectional view showing a state where pitch arrangement of the coiled wire assembled with the first core wire is achieved by the mold;

FIG. 4h is a sectional view showing a state where the assembly of the first core wire, in which pitch arrangement has been completed, and the coiled wire escapes from the mold;

FIG. 4i is a vertical and sectional view showing a state of the first core wire before performing hammering by means of a rotary hammer so as to allow the coiled wire to be completely engaged with the first core wire;

FIG. 4j is a vertical and sectional view showing the first core wire in a state where hammering is performed by means of the rotary hammer so as to allow the coiled wire to be completely engaged with the first core wire;

FIG. 4k is a vertical and sectional view showing a state of the first core wire after performing hammering by means of the rotary hammer so as to allow the coiled wire to be completely engaged with the first core wire;

FIG. 4l is a perspective view showing a state where the assembly of the first core wire and the coiled wire and the second core wire are arranged;

FIG. 4m is a perspective view showing a state where ends of the second core wire and the first core wire are inserted into both ends of a connector, respectively;

FIG. 4n is a perspective view showing a state where each one end of the second core wire and the first core wire is completely assembled with each end of the connector;

FIGS. 5a to 5d are views sequentially showing manufacturing processes of an inner cable for a push-pull control cable according to another embodiment of the present invention; and

FIGS. 6a to 6d are view sequentially showing manufacturing processes of an inner cable for a push-pull control cable according to another embodiment of the present invention.

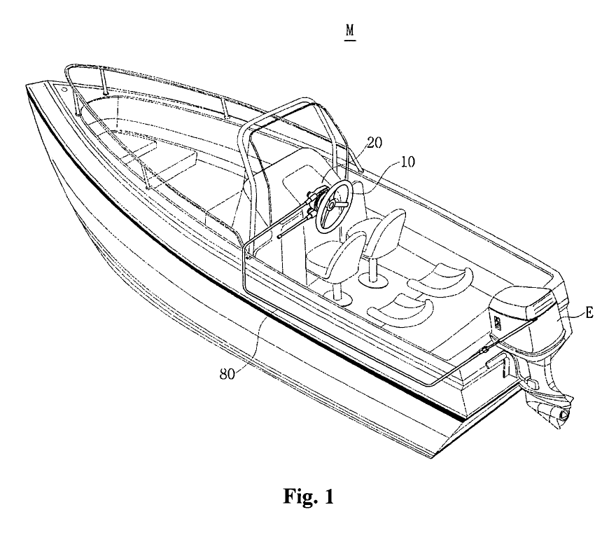

### DETAILED DESCRIPTION OF THE EXEMPLARY EMBODIMENTS

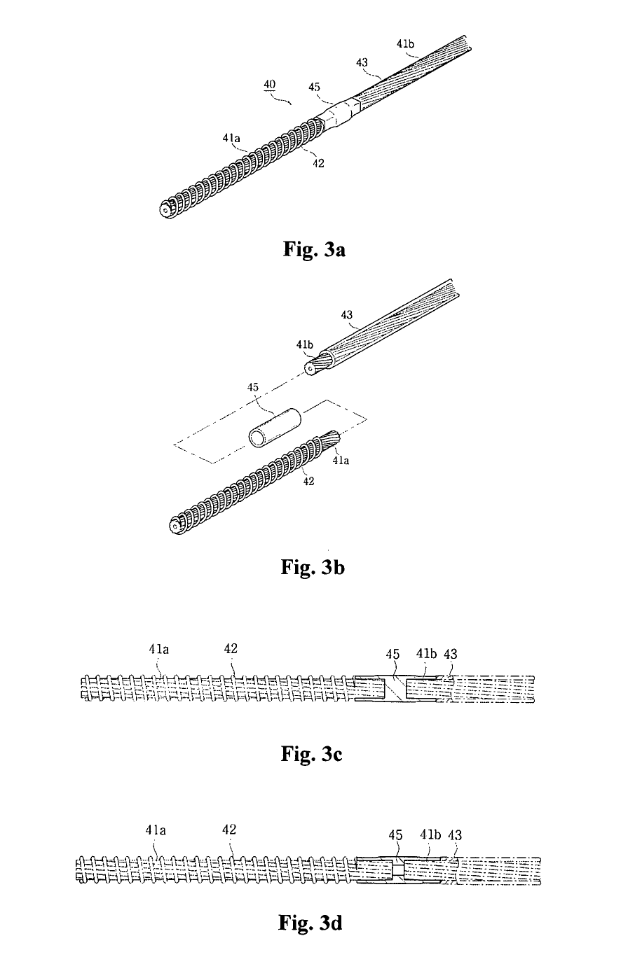

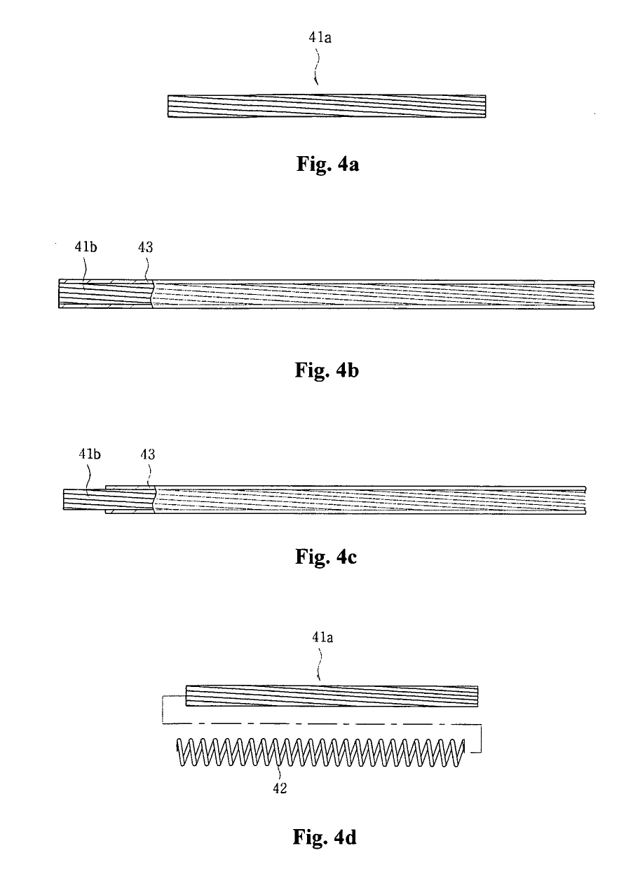

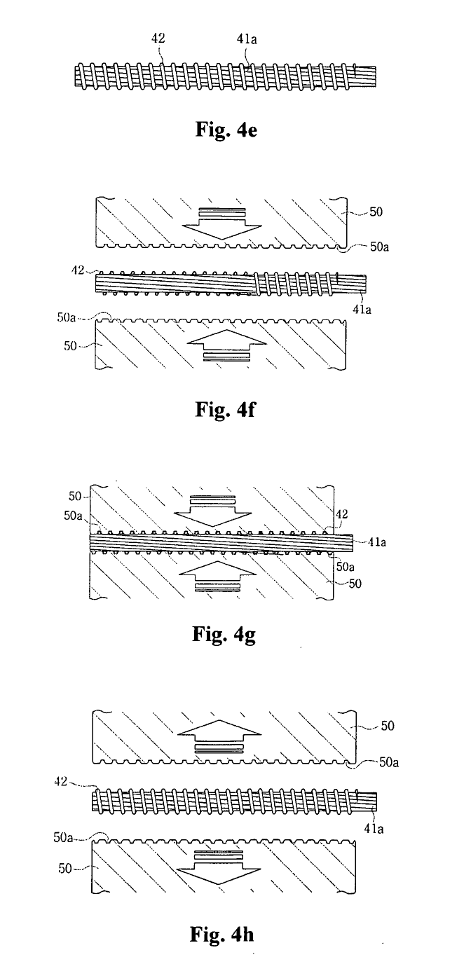

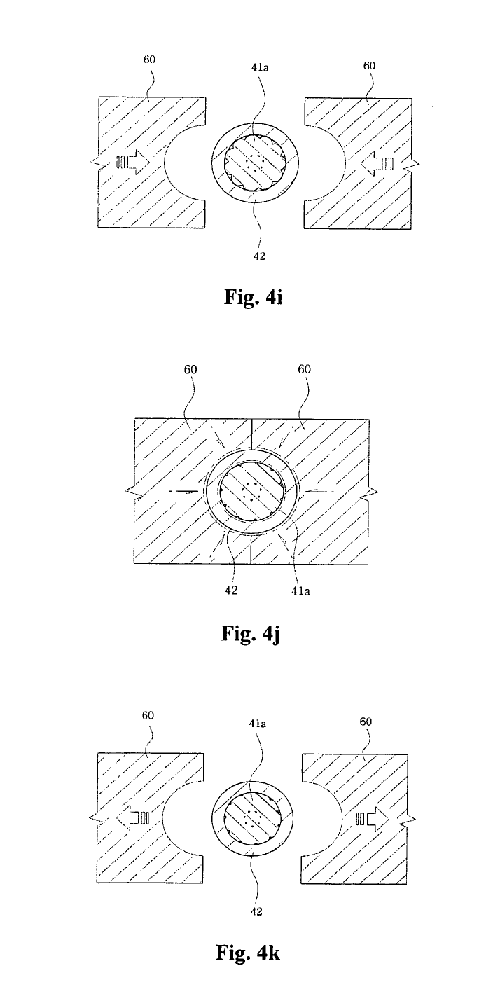

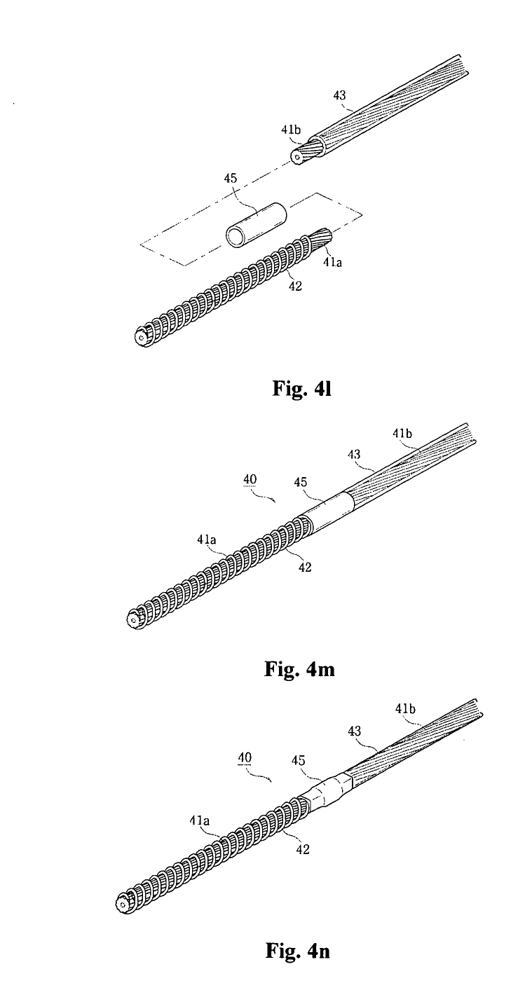

Hereinafter, an embodiment of the present invention will be described in detail with reference to FIGS. 3 and 4.

FIG. 3a is a perspective view of an inner cable for a push-pull control cable according to the present invention, FIG. 3b is an exploded perspective view of an inner cable for a push-pull control cable according to the present invention, FIG. 3c is a front view showing the assembled state of the inner cable for a push-pull control cable, which is shown in FIG. 3b, in which a connector part as a main part is shown in a sectional view, and FIG. 3d is a front view showing the assembled state of the inner cable for a push-pull control cable, which is shown in FIG. 3b, in which a connector part as a main part according to another embodiment is shown in a sectional view.

Referring to theses drawings, the inner cable 40 for a push-pull control cable according to the present invention includes: a first core wire 41a having a predetermined length, which is formed by twisting a plurality of wire strands; a coiled wire 42, which was previously manufactured in a spiral shape, independently from the first core wire, and is assembled with the first core wire in such a manner that the coiled wire is wound on an outer circumferential surface of the first core wire; a second core wire 41b, which is formed by twisting a plurality of wire strands, similarly to the first core wire, and synthetic resin coating having a predetermined thickness is formed on an outer surface of the second core wire; and a connector 45 for connecting an assembly, in which the coiled wire 42 is assembled on the outer surface of the first core wire 41a, and the second core wire 41b with each other.

At this time, the connector 45 has a thin and long barrel-shape, particularly a cylindrical shape. That is, the connector 45 is formed in a kind of a sleeve-shape.

Moreover, the connector 45 is formed in a kind of a sleeve-shape. The connector 45 can have a structure where a central part of the connector based on a longitudinal direction is blocked (see FIG. 3c), or a structure where a stepped jaw is formed at an inner side spaced a predetermined distance from both entrances (See FIG. 3d). Such structures are achieved to limit each insertion position of the first core wire 41a and the second core wire 41b so as to allow them to be easily assembled with the connector.

The coiled wire 42 of a spiral coil-shape is manufactured in such a manner that space is formed between turns so that a predetermined pitch is formed.

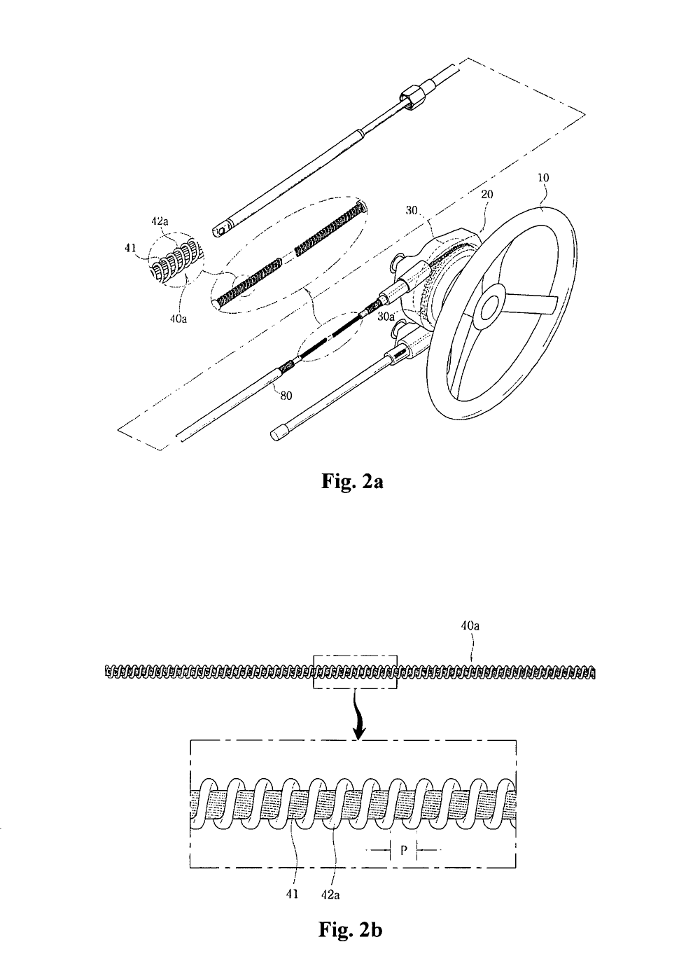

Particularly, a pitch P of the coiled wire 42 allows the coiled wire to be engaged with a gear groove 30a (see FIG. 2) of a gear box 30 (see FIG. 2) within a rotary helm 20 (see FIG. 2).

Also, the inner cable 40 for a push-pull control cable is formed in such a manner that the diameter of a part of the inner cable, on which synthetic resin coating (43) is formed, is equal to the diameter of a part thereof, with which the coiled wire 42 is assembled.

Hereinafter, manufacturing processes of the inner cable for a push-pull control cable according to the present invention, which is a structure as described above, will be described in detail with reference to FIGS. 4a to 4m.

Firstly, the first core wire 41a formed by twisting a plurality of wire strands is manufactured (see FIG. 4a).

Meanwhile, the second core wire 41b formed by twisting a plurality of wire strands, similarly to the first core wire 41a, is prepared. Then, synthetic resin coating 43 is formed in such a manner that an outer circumference of the second core wire is coated with nylon (See FIG. 4b).

Although only a part of the first core wire 41a and only a part of the second core wire 41b having the synthetic resin coating 43 are illustrated in FIGS. 4a and 4b, due to limitation of drawings, in actually, they are formed with a very long length and are controlled in a state of they being wound on bobbins (not shown), respectively.

If the first core wire 41a and the second core wire 41b having the synthetic resin coating 43 are prepared after the process as described above, each core wire wound on a bobbin is released so as to be cut into a length required for manufacturing a push-pull control cable.

For example, in a case where the first and second core wires are applied to a steering system of a motor boat M, the first core wire 41a is cut into a length corresponding to a travel road where the inner cable 40 performs reciprocal movement on an outer circumferential surface of the gear-box 30 (see FIG. 2) of the rotary helm 20, and the second core wire 41b having synthetic resin coating 43 is cut into a length connected to an engine after the travel load. That is, in a case of the inner cable for the push-pull control cable for the motor boat steering system, the length of the first core wire 41a is shorter than the length of the second core wire 41b. Therefore, the first and second core wires are cut into different lengths. Meanwhile, after releasing each core wire from the bobbin and cutting it into a length required for manufacturing an inner cable 40 for a push-pull control cable, a part of the coating 43 formed on the second core wire 41b, corresponding to one end of the second core wire, is removed (see FIG. 4c). This removal of coating is performed so as to allow the second core wire to be assembled with the connector 45, which will be described below. Separately from the above described process of preparing the second core wire 41b to be connected to the connector 45, a process of assembling a coiled wire with the first core wire 41a, which has been released from the bobbin and cut into a necessary length, (see FIGS. 4d to 4h) and a process of setting the coiled wire on the first core wire (see FIGS. 4i to 4k) are progressed.

That is, after preparing the coiled wire 42 with a required length, which had been previously formed in a spiral coil-shape separately from each core wire manufacturing process, in a state of the coiled wire being aligned in such a manner that one end of the coiled wire corresponds to one end of the first core wire 41a (see FIG. 4d), the coiled wire 42 is completely assembled with the first core wire 41a through the one end thereof (see FIG. 4e). Herein, if the coiled wire is pushed in such a manner that it is rotated in a spiral direction in a state where one end of the coiled wire 42 corresponds to one end of the first core wire 41a, the coiled wire 42 is assembled with the first core wire in such a manner that it is moved frontward along an outer circumferential surface of the first core wire, which is formed by twisted strands, according to a method similar to a screw assembling method. At this time, in a state where assembling the coiled wire 42 is completed, one end of the first core wire 41a is exposed out of the coiled wire 42 without winding of the coiled wire so as to be assembled with the connector 45.

Meanwhile, after the coiled wire 42 and the first core wire 41a are assembled with each other as described above, a process for adjusting a pitch of the coiled wire 42 is successively performed because the pitch can be changed in the process where the coiled wire 42 is assembled the first core wire 41a along the outer circumferential surface of the first core wire.

That is, after the assembly of the first core wire 41a and the coiled wire 42 is inserted into a mold 50 having grooves 50a so as to arrange the pitch of the coiled wire 42 assembled with the first core wire 41a (see FIG. 4f), if an upper mold and a lower mold correspond to each other, the coiled wire 42 assembled with the first core wire 41a is fitted in the grooves 50a of the mold 50, which had a regular pitch, due to pressure applied by the mold 50 so that pitch arrangement is achieved (see FIG. 4g).

Also, after arranging the pith of the coiled wire 42 assembled with the first core wire 41a is completed, the assembly of the first core wire 41a and the coiled wire 42 escapes from the mold 50 (see FIG. 4h).

As such, after the pitch arrangement is completed by the mold, a swaging process for allowing the coiled wire 42 to be engaged with the first core wire 41a so as to be completely settled thereon is performed. This process is performed by means of a rotary hammer 60 (see FIGS. 4i to 4k).

That is, according to hammering performed respective to the coiled wire 42 by the rotary hammer 60, uniform pressure is applied to the coiled wire 42 along a circumferential direction at the same time so that the coiled wire 42 is engaged with the outer circumferential surface of the first core wire 41a to be completely settled thereon. As a result, movement of the coiled wire 42 in a longitudinal direction of the first core wire 41a is prevented.

In this case, if it is assumed that total strength of external force (i.e. pushing force) which is applied to the coiled wire 42 assembled with the first core wire 41a so as to achieve pitch arrangement and final settlement is 100%, force of about 80% is applied in arranging the pitch by the mold 50, and force of about 20% is applied during the hammering operation performed by the rotary hammer 60.

Meanwhile, after preparing the assembly of the core wire 41a and the coiled wire 42 and second core wire having one end, from which synthetic resin coating 43 has been removed, they are connected with each other through the connector 45.

That is, in a state (see FIG. 4l) where the assembly of the first core wire 41a and the coiled wire 42, the connector 45, and the second core wire are aligned, one end of the first core wire 41a of the assembly is inserted into one side of the connector 45, and on the other hand, the end of the second core wire 41b, from which the synthetic resin coating has been removed, is inserted into the other side of the connector 45 (see FIG. 4m). Then, both sides of the connector 45 are pressed by a press (not shown), etc. so that each end of the first core wire 41a and the second core wire 41b is settled in the connector 45 in such a manner that it is engaged with the connector 45 so as not to be released therefrom. Accordingly, the inner cable 40 for a push-pull control cable is completely manufactured (see FIG. 4n).

Meanwhile, the operation of the inner cable 40 for a push-pull control cable according to the present invention, which is manufactured as described above in a case of the inner cable being applied to a steering system, is illustrated below.

In a case where the inner cable 40 for a push-pull control cable according to the present invention is applied to a steering system, the coiled wire 42 is formed at only an initial part of the inner cable, which is assembled with the rotary helm 20 so as to receive operational force therefrom. Therefore, the inner cable accurately transfers the operational force. Also, the remaining part of the inner cable 40, which is connected by the connector 45, is coated with nylon instead of the coiled wire 42, so that the inner cable can be flexibly operated through whole sections.

Accordingly, since the second core wire 41b does not generate unnecessarily big supporting force in a curved section, the inner cable 40 for a push-pull control cable is flexibly operated in the curved section so as to transfer operational force to an engine E while operating a steering wheel 10 so as to adjust a direction of the engine E.

Furthermore, differently from a conventional push-pull control cable, the inner cable 40 for a push-pull control cable according to the present invention has the coiled wire 42 assembled with only the first core wire directly connected with the gear box 30. Therefore, it is possible to reduce manufacturing cost of the inner cable 40 for a push-pull control cable.

That is, according to a conventional technique, an unnecessary wire applying tension has to be wound on whole part of the inner cable 40 for a push-pull control cable while having a spiral shape. However, the inner cable 40 for a push-pull control cable according to the present invention has the coiled wire 42 assembled with a part thereof, and not with the entire part of the inner cable.

In addition, the present invention discloses a structure where the coiled wire 42 is assembled with the first core wire 41a in such a manner that it is moved frontward along an outer circumferential surface, which is formed by twisted strands, of the first core wire 41a according to a method similar to a screw assembling method when the coiled wire 42 is assembled with the first core wire 431a. Therefore, a difficult process of winding a wire on a whole part of a conventional inner cable while applying tension can be omitted.

Particularly, the conventional inner cable for a push-pull control cable needs a separate thermal process for preventing wound wire from being released from the inner cable. Meanwhile, the inner cable 40 for a push-pull control cable according to the present invention does not need a thermal process so that the physical properties of the cable are not changed. Therefore, the inner cable maintains tension so that durability can be improved.

Due to this, when a direction of the engine E is changed according to operation of the steering wheel 10, operational force is transferred without any change so that the direction can be further smoothly changed.

Also, entire parts of the inner cable 40 for a push-pull control cable according to the present invention, except for a part where the coiled wire 42 is assembled, are coated with nylon. Therefore, for example, in a case of the inner cable is applied to a motor boat, the coating prevents salts in sea water from permeating into the second core wire 41b while a part of the inner cable 40, which is connected with the engine E, is continuously exposed to sea water with high salinity. As a result, reduction of the cable life due to generation of rust is prevented.

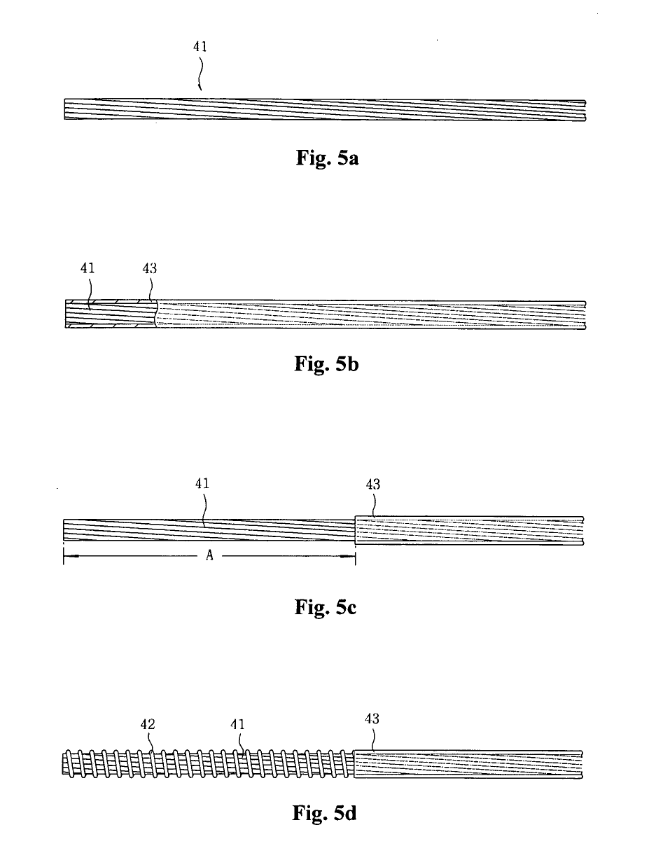

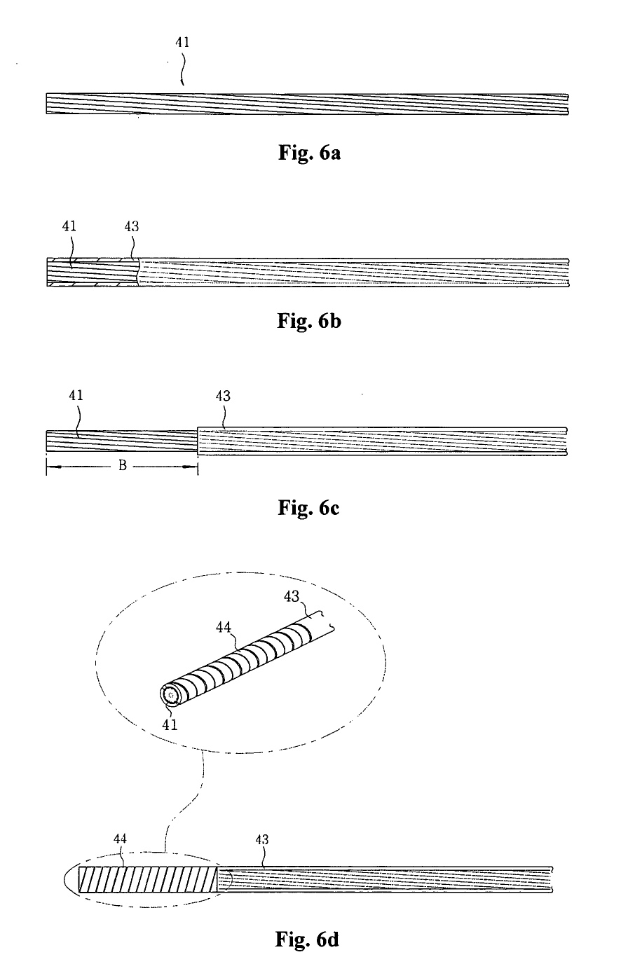

Meanwhile, FIGS. 5 and 6 are views showing an inner cable for a push-pull control cable according to other embodiments of the present invention and a method for manufacturing the inner cable. Hereinafter, they will be described in detail.

FIGS. 5a to 5d are views sequentially showing manufacturing processes of an inner cable for a push-pull control cable according to another embodiment of the present invention. The inner cable for a push-pull control cable according to another embodiment of the present invention includes a core wire 41 having a predetermined distance, which is formed by twisting a plurality of wire strands, synthetic resin coating 43 formed on a predetermined area of the core wire 41, and a coiled wire 42 of a spiral shape, which is assembled with the core wire in such a manner that the core wire surrounds an outer circumferential surface of part A of the core wire, the part A being a remaining part, except for a part covered by the synthetic resin coating.

A manufacturing process of manufacturing the inner cable for a push-pull control cable, which is structured as described above, will be described below.

Firstly, the core wire 41 formed by twisting a plurality of wires is prepared (see FIG. 5a), and a synthetic resin coating 43 is formed on an outer circumferential surface of the core wire 41 through nylon coating (see FIG. 5b).

In FIGS. 5a and 5b, although a part of the core wire 41 is illustrated, in actually, the core wire 41 is successively formed with a very long length and is controlled in a state of the core wire 41 being wound on a bobbin (not shown).

After the core wire 41 coated with the synthetic resin coating 43 is prepared as described above, the core wire is released from the bobbin so as to be cut into a length required for manufacturing a push-pull control cable.

Also, synthetic resin coating 43 coated on a predetermined part A of the cut core wire 41 is removed (see FIG. 5c). This part A is a part to be assembled with the coiled wire 42. That is, synthetic resin coating 43 of a part of the core wire 41, with which the coiled wire is assembled, is removed.

Meanwhile, separately from the process of manufacturing the core wire 41, the coiled wire 42 formed in a spiral coil-shape is prepared to have a required length (i.e. a length corresponding to part A).

Subsequently, the prepared coiled wire 42 is aligned in such a manner that it corresponds to an end part of the core wire 41, from which coating has been removed. Then, the coiled wire 42 is assembled with the core wire 41 through the end of the core wire (see FIG. 5d).

Here, in the state where the coiled wire 42 corresponds to the end of the core wire 41, if the coiled wire 42 is pushed toward the core wire while the coiled wire is rotated in a spiral direction, the coiled wire 42 is assembled with the core wire by a method similar to a screw assembling method while moving frontward along an outer circumferential surface formed by twisting wires.

Meanwhile, a pitch of the coiled wire 42 can be changed during a process of pushing the coiled wire 42 along the outer circumferential surface of the core wire 41. Therefore, after the coiled wire 42 is assembled with the core wire 41 as described above, a process for adjusting the pitch of the coiled wire is performed.

That is, a process for arranging the pitch of the coiled wire 42 assembled with the core wire 41 is performed. This process can be easily understood with reference to FIGS. 4f to 4h illustrating the above described embodiment.

After the pitch of the coiled wire 42 assembled with the core wire 41 is completely arranged, a swaging process for allowing the coiled wire 42 to be settle on the core wire 41 in such a manner that it is engaged with the core wire is performed. A detailed description of this process will be omitted because it can be easily understood with reference to FIG. 4i to 4k, which illustrates the process in the above described embodiment.

FIGS. 6a to 6d are view sequentially showing manufacturing processes of an inner cable for a push-pull control cable according to another embodiment of the present invention. The inner cable for a push-pull control cable according to another embodiment of the present invention includes: a core wire 41 with a predetermined length, which is formed by twisting a plurality of wires strands; synthetic resin coating 43 formed on a predetermined part of the core wire 41; and an armor 44, which is assembled with part B of the core wire, which is a remaining part, except for the part coated with the synthetic resin coating, in such a manner that the armor surrounds an outer circumferential surface of the core wire.

A process of manufacturing the inner cable for a push-pull control cable according to the embodiment of the present invention, which is structured as described above, will be described below.

Firstly, the core wire 41 formed by twisting a plurality of wires is prepared (see FIG. 6a), and the synthetic resin coating 43 is formed on an outer circumferential surface of the core wire through nylon coating (see FIG. 6b).

In FIGS. 6a and 6b, a portion of the core wire 41 is illustrated due to limitation of the drawings. However, in actual, the core wire is successively formed with a very long distance and is controlled in a state of the core wire being wound on a bobbin (not shown).

The core wire 41 coated with the synthetic resin coating 43, which has been prepared in a state of it being wound on the bobbin, is cut into a length required for manufacturing a push-pull control cable.

Also, in a state where the core wire 41 coated with the synthetic resin coating 43 has been cut into a required length, a part of the synthetic resin coating 43, which corresponds to the predetermined part B, which is one end of the core wire 41, is removed (see FIG. 6c). This part B is a part to be assembled with the armor 44.

That is, the synthetic resin coating 43 of a part of the core wire 41, with which the armor 44 will be assembled, is removed.

Subsequently, after the armor 44, which has been formed separately from the process of manufacturing the core wire 41 coated with the synthetic resin coating 43, is prepared with a required length (i.e. a length corresponding to part B), the armor 44 is aligned so as to correspond to an end of the core wire 41, from which the coating is removed. Then, the armor 44 is assembled with the core wire 41 through the end of the core wire (see FIG. 6d).

Herein, the armor 44 has a diameter larger than a diameter of the core wire 41. Therefore, the armor 44 can be assembled with the core wire by an operation of pushing the armor 44 frontward in a state where the armor 44 corresponds to the end of the core wire.

Meanwhile, after the armor 44 is assembled through the end of the core wire 41, hammering is performed by a rotary hammer so as to allow the armor 44 to be settled on the core wire 41.

In a case of the armor 44, differently from the coiled wire according to the embodiment described above, there is no need for considering pitch arrangement.

During the process, the armor 44 undergoes tempering before it is assembled with the core wire 41. An operation of removing inner stress in such a manner that tissues of the armor 44 is softened and stabilized through tempering is performed so as to allow the armor 44 to be easily settled on the core wire 41 in performing hammering to the armor.

Meanwhile, the present invention is not limited to the above described embodiments, and is defined according to the accompanying claims, and those skilled in the art will appreciate that various modifications, additions and substitutions are possible, without departing from the scope and spirit of the invention as disclosed in the accompanying claims.

What is claimed is:

1. An inner cable for a push-pull control cable, the inner cable comprising:
a first core wire formed by twisting a plurality of wire strands;
a coiled wire, which has a spiral shape and is assembled with the first core wire in such a manner that the coiled wire surrounds an outer circumferential surface of the first core wire;
a second core wire formed by twisting a plurality of wire strands similarly to the first core wire, the second core wire having an outer surface coated with synthetic resin coating; and
a connector for connecting an assembly, which is formed by assembling the coiled wire with an outer surface of the first core wire, and the second core wire with each other.

2. The inner cable for a push-pull control cable as claimed in claim 1, wherein the synthetic resin coating is made from nylon material.

3. The inner cable for a push-pull control cable as claimed in claim 1, wherein the connector is shaped like a slim and long barrel.

4. The inner cable for a push-pull control cable as claimed in claim 3, wherein the connector has a structure where a central portion of the connector based on a longitudinal direction of the connector is blocked.

5. The inner cable for a push-pull control cable as claimed in claim 3, wherein the connector has a stepped jaw, in which the inner cable is locked, formed at an inner side of the connector, which is spaced a predetermined distance from an entrance of the connector.

6. A method for manufacturing an inner cable for a push-pull control cable, the method comprising the step of:
forming an assembly in such a manner that a coiled wire of a spiral coil-shape is assembled with a first core wire through one end of the first core wire;
forming a second core wire by coating synthetic resin having a predetermined thickness on an outer surface of the second core wire, the second core wire being a wire formed by twisting a plurality of wire strands similarly to the first core wire; and
connecting the assembly, which is formed by assembling the coiled wire with the outer surface of the first core wire, with the second core wire with each other through a connector.

7. The method as claimed in claim 6, further comprising the step of arranging a pitch of the coiled wire assembled with the first core wire.

8. The method as claimed in claim 6, wherein the pitch of the coiled wire is arranged in such a manner that the coiled wire is inserted into grooves of an upper mold and a lower mold as the upper mold and the lower mold correspond to each other in a state where the assembly of the first core wire and the coiled wire is positioned between the upper mold and the lower mold, which have the grooves with a predetermined pitch.

9. The method as claimed in claim 8, further comprising the step of performing hammering to an outer circumferential surface of the coiled wire so as to allow the coiled wire to be engaged with the outer circumferential surface of the core wire after arranging the pitch of the coiled wire.

10. The method as claimed in claim 6, wherein the coiled wire is assembled with an outer circumferential surface of the core wire while the coiled wire is rotated in a spiral direction.

11. The method as claimed in claim 6, wherein the synthetic resin coating may be nylon coating.

12. The method as claimed in claim 6, wherein the step of connecting the assembly, which is formed by assembling the coiled wire with the outer surface of the first core wire, with the second core wire through the connector includes the step of inserting ends of the first core wire and the second core wire into both sides of the connector, respectively, and the step of settling each end of the assembly and the second core wire in the connector in such a manner that an outer circumferential surface of the connector is pressed so that the ends of the assembly and the second core wire to be engaged with both sides of the connector so as to prevent the ends from releasing from the connector.

13. An inner cable for a push-pull control cable, the inner cable comprising:
a core wire having a predetermined length, the core wire being formed by twisting a plural of wire strands;
synthetic resin coating formed on a predetermined part of the core wire; and
a coiled wire of a spiral shape, the coiled wire surrounding an outer circumferential surface of a remaining part of the core wire, except for the part coated with synthetic resin.

14. A method for manufacturing an inner cable for a push-pull control cable, the method comprising the steps of:
forming a core wire by twisting a plurality of wire strands;
coating an outer surface of the core wire with synthetic resin with a predetermined thickness;
removing a predetermined part of the synthetic resin, with which one side end of the core wire is coated;
assembling a coiled wire of a spiral shape with the part of the core wire, from which synthetic resin coating has been removed;
arranging a pitch of the coiled wire; and
settling the coiled wire on the core coil.

15. An inner cable for a push-pull control cable, the inner cable comprising:
a core wire having a predetermined length, the core wire being formed by twisting a plurality of wire strands;
synthetic resin coating formed on a predetermined part of the core wire; and
an armor assembled with a remaining part of the core wire, except for the part coated with synthetic resin, in such a manner that the armor surrounds an outer circumferential surface of the core wire.

16. A method for manufacturing an inner cable for a push-pull control cable, the method comprising the steps of:
forming a core wire by twisting a plurality of wire strands;
coating an outer surface of the core wire with synthetic resin with a predetermined thickness;
removing a predetermined part of the synthetic resin, which one side end of the core wire is coated;
assembling an armor of a spirally winding shape, with the part of the core wire, from which synthetic resin coating has been removed; and
settling the armor on the core wire.
